(19) United States
(12) Patent Application Publication
(10) Pub. No.: US 2026/0305700 A1
(43) Pub. Date: Oct. 8, 2026

(54) HEATING ASSEMBLY, ATOMIZER AND AEROSOL GENERATING DEVICE

(71) Applicant: Shenzhen Woody Vapes Technology Co., Ltd., Shenzhen, Guangdong (CN)

(72) Inventors: Pengzhan AN, Shenzhen, Guangdong (CN); Lingquan WANG, Shenzhen, Guangdong (CN); Xiaopeng XIAO, Shenzhen, Guangdong (CN); Chunhua WEI, Shenzhen, Guangdong (CN)

(73) Assignee: Shenzhen Woody Vapes Technology Co., Ltd., Shenzhen, Guangdong (CN)

(21) Appl. No.: 19/483,251

(22) PCT Filed: Apr. 24, 2024
(86) PCT No.: PCT/CN2024/089656

§ 371 Date: Nov. 11, 2025

(30) Foreign Application Priority Data
May 12, 2023 (CN) 202321146037.6

(51) Int. Cl. A24F 40/46; A24F 40/44; H05B 3/03

(52) U.S. Cl. CPC A24F 40/46; A24F 40/44; H05B 3/03

(57) ABSTRACT

Disclosed are a heating assembly, an atomizer, and an aerosol generating device. The heating assembly is disposed on at least one surface of a porous substrate. The porous substrate is configured to guide an aerosol-forming matrix. The heating assembly comprises two electrode connection portions configured to be connected to electrodes and a heating element connected between the two electrode connection portions. Both ends of the heating element each have a same arc-shaped structure with a variable radius of curvature, and a connection point between the arc-shaped structure and each of the electrode connection portions is disposed close to a center of the heating element.

The present disclosure claims priority to Chinese Patent Application No. 202321146037.6, filed on May 12, 2023 and entitled “HEATING ASSEMBLY, ATOMIZER, AND AEROSOL GENERATING DEVICE”, the entire contents of which are incorporated herein by reference.

### TECHNICAL FIELD

The present disclosure belongs to the field of atomization, and relates to a heating assembly, an atomizer, and an aerosol generating device.

### BACKGROUND

Aerosol refers to a gaseous dispersion system consisting of solid or liquid particles suspended in a gaseous medium. In the related art, since the aerosol can be introduced into a human body through respiratory system, a matrix may be generally atomized to form an aerosol for inhalation, and the aerosol-forming matrix can be effectively absorbed by the human body.

At present, most aerosol generating devices heat the aerosol-forming matrix by resistance heating. Specifically, a resistor (i.e., a heating element) heats a thermal conductor, which in turn heats the close toby aerosol-forming matrix, so as to generate the aerosol. However, in existing technologies, when the resistance is in a high temperature state for extended periods, localized areas of the resistor are prone to breakage, which reduces the service life of the heating assembly, the atomizer, or the aerosol generating device.

### SUMMARY

The aerosol-forming matrix is heated in the atomizer by a heating element, but the heating element is prone to breakage locally at high temperatures.

The present disclosure provides a heating assembly disposed on at least one surface of a porous substrate. The porous substrate is used for guiding an aerosol-forming matrix. The heating assembly comprises two electrode connection portions and a heating element connected between the two electrode connection portions. Both ends of the heating element each have a same arc-shaped structure with a variable radius of curvature, and a connection point between the arc-shaped structure and each of the electrode connection portions is disposed close to a center of the heating element.

The present disclosure also provides an atomizer including the heating assembly described above.

The present disclosure also provides an aerosol generating device including the atomizer described above.

### BENEFICIAL EFFECT

The electrode connection portion is connected to the heating element for raising the temperature of the heating element, thereby heating a portion of the aerosol-forming matrix in the porous substrate. The pores of the porous substrate is used for guiding or receiving the aerosol-forming matrix. The variable radius of curvature of the two arc-shaped structures allows for a natural transition in the connection between the heating element and the two electrode connection portions, which helps prevent breakage at the junction between the heating element and the electrode connection portions during the production and manufacturing process. Here, setting both ends of the heating element as identical arc-shaped structures reduces the thermal stress generated by uneven heating within the heating element. The heating element is provided to have the arc-shaped structure with a variable curvature and the junction between the arc-shaped structure and the electrode connection portion is arranged close to the center of the heating element, allowing the heat generated by the heating element to be more concentrated, thereby improving the atomization effect. Furthermore, it results in a smaller temperature difference between the two ends of the heating element and its central portion, thereby reducing the thermal stress generated inside the heating element.

The working principle of the heating assembly is as follows: when the two electrode connection portions are turned on, the heating element generates heat through its internal resistance. Part of the heat from the heating element can directly heat a portion of the aerosol-forming matrix, while another portion of the heat from the heating element is transferred to the porous substrate to heat another part of the aerosol-forming matrix within the pores of the porous substrate. The heating assembly provided in the embodiments of the present disclosure reduces the temperature difference between the ends of the heating element and its central portion by altering the radius of curvature of the arc-shaped structures and positioning the ends of the arc-shaped structures close to the center of the heating element. This, in turn, reduces the thermal stress in the heating element, thereby addressing the issue of localized breakage in the heating element commonly encountered in existing technologies.

On the other hand, the atomizer provided in the present disclosure is designed based on the above-described atomizing heating assembly, and the beneficial effects thereof refer to the beneficial effects of the heating module. Details are not repeated herein.

On the other hand, the aerosol generating device provided in the present disclosure is designed based on the atomizer, and the beneficial effects refer to the beneficial effects of atomizer, and details are not repeated herein.

### BRIEF DESCRIPTION OF THE DRAWINGS

FIG. 1 is an overall structural diagram of a heating assembly according to some embodiments of the present disclosure.

FIG. 2 is a top view of a heating assembly according to some embodiments of the present disclosure.

List of reference numerals:

100. Porous substrate; 200. Electrode connection portion; 300. Heating element; 310. First heating portion; 320. Second heating portion; 330, Third heating portion.

### DETAILED DESCRIPTION OF EMBODIMENTS

To provide a clear explanation of the technical means and efficacy employed by the present disclosure to achieve its intended objectives, some implementations, structures, features, and their effects are described in detail below with reference to the accompanying drawings and preferred embodiments. In the following description, the expressions such as “one embodiment” or “embodiment” do not necessarily refer to the same embodiment. Furthermore, specific features, structures, or characteristics in one or more embodiments may be combined in any suitable manner.

In the description of the present disclosure, it is to be noted that the terms such as “first” and “second” used in the specification and claims of the present disclosure, as well as the above-mentioned drawings, are intended to distinguish similar objects and do not necessarily describe a specific order or sequence. Terms such as “vertical”, “horizontal”, “longitudinal”, “front”, “rear”, “left”, “right”, “upper”, “lower”, and “level” indicate directions or positional relationships based on the directions or positional relationships shown in the drawings. These terms are used merely for the convenience of describing the present disclosure and do not imply that the referred devices or elements must have specific orientations or positions. Therefore, they should not be construed as limitations on the present disclosure.

In the description of the present disclosure, it is to be noted that, unless otherwise explicitly specified and defined, the terms “install”, “connect”, and “link” should be interpreted broadly. For example, a connection may be a fixed connection, a detachable connection, or an integral connection. Alternatively, it may be a mechanical connection or an electrical connection. It may be a direct connection, or an indirect connection through an intermediate medium. Those of ordinary skill in the art can understand the specific meanings of these terms in the present disclosure based on the actual context.

### Example 1

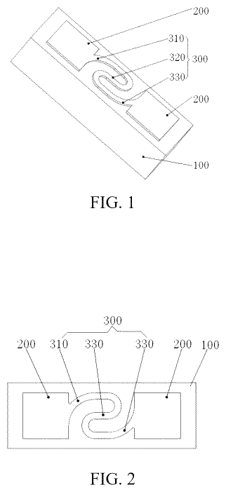

Embodiments of the present disclosure provide a heating assembly. As shown in FIGS. 1 to 2, the heating assembly is disposed on at least one surface of a porous substrate 100. The porous substrate 100 is used for guiding an aerosol-forming matrix. The heating assembly includes two electrode connection portions 200 and a heating element 300 connected between the two electrode connection portions 200. The electrode connection portions 200 are used for connecting electrodes. Both ends of the heating element 300 are of identical arc-shaped structures having variable radius of curvature. The connection between the arc-shaped structure and the electrode connection portion 200 is disposed close to the center of the heating element 300.

Specifically, the electrode connection portion 200 is connected to the heating element 300 for raising the temperature of the heating element 300, thereby heating a portion of the aerosol-forming matrix in the porous substrate 100. The variable radius of curvature of the two arc-shaped structures allows for a natural transition in the connection between the heating element 300 and the two electrode connection portions 200, which helps prevent breakage at the junction between the heating element 300 and the electrode connection portions 200 during the production and manufacturing process. Here, setting both ends of the heating element 300 as identical arc-shaped structures reduces the thermal stress generated by uneven heating within the heating element 300. The heating element 300 is provided to have the arc-shaped structure with a variable curvature and the junction between the arc-shaped structure and the electrode connection portion 200 is arranged close to the center of the heating element 300, allowing the heat generated by the heating element 300 to be more concentrated, thereby improving the atomization effect. Furthermore, it results in a smaller temperature difference between the two ends of the heating element 300 and its central portion, thereby reducing the thermal stress generated inside the heating element 300. The heating element 300 and the electrode connection portions 200 are integrally formed.

The working principle of the heating assembly is as follows: when the two electrode connection portions 200 are turned on, the heating element 300 generates heat through its internal resistance. Part of the heat from the heating element 300 can directly heat a portion of the aerosol-forming matrix, while another portion of the heat from the heating element 300 is transferred to the porous substrate 100 to heat another part of the aerosol-forming matrix within the pores of the porous substrate 100. The heating assembly provided in the embodiments of the present disclosure reduces the temperature difference between the ends of the heating element 300 and its central portion by altering the radius of curvature of the arc-shaped structures and positioning the ends of the arc-shaped structures close to the center of the heating element 300. This, in turn, reduces the thermal stress in the heating element 300, thereby addressing the issue of localized breakage in the heating element 300 commonly encountered in existing technologies.

In a specific embodiment, the radius of curvature of the arc-shaped structure gradually increases from the central portion of the heating element 300 toward the electrode connection portions 200.

Specifically, both ends of the heating element 300 are designed as arc-shaped structures, and the radius of curvature of these arc-shaped structures gradually increases in the direction toward the electrode connection portions 200. This design ensures a more natural transition at the junctions between the heating element 300 and the electrode connection portions 200, further preventing issues of breakage at these connection points between the heating element 300 and the electrode connection portions 200.

In a specific embodiment, the electrode connection portions 200 are in a rectangular shape, and the arc-shaped structures are tangent to the side edge of the rectangular electrode connection portion 200.

Specifically, the two opposite sides of the rectangular electrode connection portions 200 can concentrate the heat generated by the heating element 300. This allows for more uniform heating of the heating element 300, and the concentrated heat enables more thorough heating of the aerosol-forming matrix. It is to be noted that the electrode connection portion 200 includes, but is not limited to, a rectangular structure, and may also be another structure having a heat-concentrating properties.

In a specific embodiment, the heating element 300 includes a first heating portion 310, a second heating portion 320, and a third heating portion 330, which are connected in sequence. The first heating portion 310 and the third heating portion 330 each have an arc-shaped structure with a variable radius of curvature, and the second heating portion 320 has a symmetrical or centrally symmetrical structure.

Specifically, the first heating portion 310 and the third heating portion 330 have the same radius of curvature, and the second heating portion 320 may be of a centrally symmetrical structure. This allows for more uniform heating of the heating element 300, resulting in relatively lower thermal stress. Consequently, the heating element 300 is less prone to breakage and has a longer service life. It is to be noted that the second heating portion 320 can also be an axisymmetrical structure.

Further, the second heating portion 320 includes at least two U-shaped structures connected end to end.

As shown in FIGS. 1 and 2, the second heating portion 320 has two U-shaped structures connected end to end. The two U-shaped structures are symmetrical in center, and any two adjacent side edges of the two U-shaped structures are equally spaced. This configuration ensures more uniform heating of the heating element 300, making it less prone to breakage and extending its service life. It is to be noted that the second heating portion 320 can also consist of two C-shaped structures connected end to end, with the two C-shaped structures being centrally symmetrical.

In a specific embodiment, the first heating portion 310, the second heating portion 320, and the third heating portion 330 have equal widths.

Specifically, the first heating portion 310, the second heating portion 320, and the third heating portion 330 each have a bar-shaped structure with uniform widths, thereby ensuring more uniform heating of the heating element 300 and reducing the likelihood of localized breakage.

In a specific embodiment, the material of the heating element 300 is a thermally conductive metal, for example, copper.

Specifically, the heating element 300 may be formed by different processing methods such as thick-film screen printing, transfer printing, electroplating, etching, and the like.

In specific embodiment, the porous substrate 100 is made of a ceramic material.

Specifically, the porous substrate 100 includes thermally conductive porous substrates such as silicon-based porous ceramics, aluminum-based porous ceramics, and diatomaceous earth ceramics. The pores on the substrate are used to guide or receive the aerosol-forming matrix.

### Example 2

Embodiments of the present disclosure provide an atomizer comprising the heating assembly of Example 1.

The atomizer includes an aerosol-forming matrix storage chamber, and the porous substrate 100 is in communication with the aerosol-forming matrix storage chamber. By arranging both ends of the heating assembly in the atomizer as an arc-shaped structure with variable curvature, and arranging the connection point between the arc-shaped structure and the electrode connection portion close to the center of the heating element 300, the temperature difference between the end of the heating element 300 and the center of the heating element 300 is reduced. This, in turn, reduces the thermal stress in the heating element 300, thereby solving the problem in the prior art where the heating element 300 is prone to localized breakage.

### Example 3

Embodiments of the present disclosure provide an aerosol generating device including the atomizer of Example 2.

Specifically, the aerosol generating device includes a housing, an atomizer, and a battery. An air inlet and an air outlet are disposed on a side wall of the housing. The air inlet, the atomization chamber of the atomizer, and the air outlet are communicated in sequence to form an atomization channel so as to guide the atomized matrix. The battery is connected to the atomizer for supplying electric power to the atomizer. The aerosol generating device provided in the present disclosure improves the problem that the heating element 300 is prone to breakage through the heating assembly of Example 1, thereby further enhancing the atomization effect and service life of the aerosol-generating device.

In summary, it will be readily appreciated by those skilled in the art that each of the above advantageous features may be freely combined and superimposed without conflict.

The foregoing descriptions are merely preferred embodiments of the present disclosure and are not intended to limit the application in any form. Any simple modifications, equivalent variations, or amendments made to the above embodiments based on the technical essence of the present disclosure shall still fall within the scope of the technical solutions of the present disclosure.

1. A heating assembly disposed on at least one surface of a porous substrate, wherein the porous substrate is configured to guide an aerosol-forming matrix, the heating assembly comprises two electrode connection portions configured to be connected to electrodes and a heating element connected between the two electrode connection portions;
both ends of the heating element each have a same arc-shaped structure with a variable radius of curvature, a connection point between the arc-shaped structure and each of the electrode connection portions is disposed close to a center of the heating element; and
the radius of curvature of the arc-shaped structure gradually increases from a central portion of the heating element towards the electrode connection portions

2. The heating assembly according to claim 1, wherein the electrode connection portions are in a rectangular shape, and the arc-shaped structure is tangent to a side edge of each of the electrode connection portions in the rectangular shape.

3. The heating assembly according to claim 1, wherein the heating element comprises a first heating portion, a second heating portion, and a third heating portion connected in sequence, the first heating portion and the third heating portion each have the arc-shaped structure with the variable radius of curvature, and the second heating portion has a symmetrical or centrally symmetrical structure.

4. The heating assembly according to claim 3, wherein the second heating portion comprises at least two U-shaped structures connected end to end.

5. The heating assembly according to claim 4, wherein distances from the two U-shaped structures to side edges of the two electrode connection portions, respectively, are equal.

6. The heating assembly according to claim 3, wherein the second heating portion comprises two C-shaped structures connected end to end, and the two C-shaped structures have a centrally symmetrical structure.

7. The heating assembly according to claim 3, wherein the first heating portion and the third heating portion have a same radius of curvature.

8. The heating assembly according to claim 3, wherein the first heating portion, the second heating portion, and the third heating portion have equal widths.

9. The heating assembly according to claim 3, wherein the first heating portion, the second heating portion, and the third heating portion each have a bar-shaped structure.

10. The heating assembly according to claim 1, wherein a material of the heating element is a thermally conductive metal, and the thermally conductive metal is copper.

11. The heating assembly according to claim 1, wherein the porous substrate is made of a ceramic material.

12. The heating assembly according to claim 11, wherein the porous substrate is one of a silicon-based porous ceramic, an aluminum-based porous ceramic, and a diatomaceous earth ceramic.

13. An atomizer comprising the a heating assembly, wherein the heating assembly is disposed on at least one surface of a porous substrate, wherein the porous substrate is configured to guide an aerosol-forming matrix, the heating assembly comprises two electrode connection portions configured to be connected to electrodes and a heating element-connected between the two electrode connection portions;
both ends of the heating element each have a same arc-shaped structure with a variable radius of curvature, a connection point between the arc-shaped structure and each of the electrode connection portions is disposed close to a center of the heating element; and
the radius of curvature of the arc-shaped structure gradually increases from a central portion of the heating element towards the electrode connection portions.

14. An aerosol generating device comprising the atomizer according to claim 13.
